(19) United States
(12) Patent Application Publication
(10) Pub. No.: US 2016/0132835 A1
(43) Pub. Date: May 12, 2016

(54) Method and system for decision support in relation to geolocalization of a candidate's residence and workplace

(71) Applicant: SIGMA RH SOLUTIONS INC., Montréal (CA)

(72) Inventor: Patrice POIRIER, Montreal (CA)

(73) Assignee: Sigma-RH Solutions Inc., Montreal, Quebec (CA)

(21) Appl. No.: 14/896,060

(22) PCT Filed: Jun. 6, 2014
(86) PCT No.: PCT/IB2014/062039

§ 371 Date: Dec. 4, 2015

(30) Foreign Application Priority Data
Jun. 7, 2013 (CA) 2818117

(51) Int. Cl. G06Q 10/10; G01C 21/20; G01C 21/34

(52) U.S. Cl. CPC G06Q 10/1053; G01C 21/3492; G01C 21/20

(57) ABSTRACT

Process for analyzing the geolocalization data of the work sites, the employees' or the candidates' place of residence (current or future) for one or several companies in order to calculate the travel time (for several modes of transportation) and the distance between each location, based on several search criteria. The invention allows one or more users to view the travel time and/or distance in relation to a worksite at the time of selection of a candidate or an employee for a given job. It may also allow an employee to find a job that matches a specific travel time. Employees could also find a home that is located within a specific travel time from their current or future place of work. Currently, the travel time cannot be included into massive calculation when decision analyses are needed for these types of choices. The present invention allows the integration of such options.

### CROSS-REFERENCE TO RELATED APPLICATIONS

The present patent application claims the benefits of priority of the Canadian Patent Application No. 2,818,117, entitled “Système et procédé d'analyse des données de géolocalisation du domicile (actuel ou futur) d'un salarié, d'un candidat et d'un lieu de travail (actuel ou futur) pour prendre des décisions” and filed at the Canadian Patent Office on Jun. 7, 2013, which is herein incorporated by reference to the present application.

### FIELD OF THE INVENTION

The present invention generally relates to systems and methods for decision making in relation to geolocalization of person's residence and workplace. More specifically, the present invention relates to systems and methods for decision making in relation to geolocalization of employees' residence and workplace.

### BACKGROUND OF THE INVENTION

Decision-support tools for candidates have been around for a long time on the market. These tools assess candidates based on their skills, education and previous jobs. However, no tool can provide the travel time between the place of work and the employee's or candidate's place of residence. Nevertheless, according to a recent study, 46% of French employees would consider changing jobs to reduce their travel time. To increase the retention rate of employees in companies, we wanted to add the travel time as one of the factors in our decision-support tool.

### SUMMARY OF THE INVENTION

According to one aspect of the present invention, a decision support system in relation to the position of residence of a user is disclosed. The system typically comprises at least one data source, at least one client device, an application server and a computer network connecting the at least one client device to the application server.

According to another aspect of the present invention, the at least one data source is typically configured to store a plurality of location information, a plurality of geolocalization data associated to at least one stored location information and a plurality of worksites information associated to at least one geolocalization data.

According to another aspect of the present invention, the at least one client device is generally configured to input at least one residence information of the user.

According to another aspect of the present invention, the application server is generally configured to receive the at least one residence information of the user, receive at least one criterion relating to the worksite, fetch geolocalization data associated to the worksite relating to the at least one criterion from the at least one data source, retrieve geolocalization data of the at least one received location information, compute at least one travel parameters between each fetched geolocalization data associated to the worksite and the retrieved geolocalization data from the at least one received location information.

According to another aspect of the present invention, a decision support system in relation to the location of the worksite of a user is disclosed. The system generally comprises at least one data source, such as a relational database or a XML file, configured to store, at least one client device preferably configured to input at least one worksite information of the user, an application server and a computer network generally connecting the at least one client device to the application server.

According to another aspect of the present invention, the at least one data source is generally configured to store a plurality of geolocalization data associated to at least one residence location information available for rent or for sale and a plurality of worksites information associated to at least one geolocalization data.

According to another aspect of the present invention, the application server is configured to receive the at least one worksite information of the user, fetch geolocalization data associated to the location available for rent or for sale relating to the at least one criterion from the at least one data source, retrieve geolocalization data of the at least one worksite location information, compute at least one travel parameters between each fetched geolocalization data associated to each fetched location available for sale or rent and the retrieved geolocalization data from the at least one receive worksite location information fetch the one or more residence locations information available for sale or for rent having at least one computed travel parameters which is inferior to at least one respective predetermined travel parameter.

According to another aspect of the present invention, a method for decision support in relation to the position of residence of a user is disclosed. The method typically comprises the step to input at least one residence information of the user, fetch geolocalization data associated to the worksite relating to the at least one criterion from the at least one data source, retrieve geolocalization data of the at least one received location information, compute at least one travel parameter between each fetched geolocalization data associated to the worksite and the retrieved geolocalization data data from the at least one receive location information, fetch the one or more stored worksites information having at least one computed travel parameters which is inferior to at least one respective predetermined travel parameter and communicate and display the fetch stored worksite information on a client device connected to the system through a computer network.

To help recruitment staff: The system may massively calculate the travel time of employees or candidates between their place of residence and their place of work, and display the results to the recruiters to help them make their decision when they select a candidate for a given job.

For job seekers: The system may massively calculate the travel time between their place of residence and job offers that match their needs in order to add this factor when searching for jobs where they can apply.

For home buyers: The system may massively calculate the travel time between their place of work and the available homes that match the buyers' needs, and display the results to help them make their decision.

The travel time must be calculated with various modes of transportation (depending on availability). This could include the travel time by car, by public transit (train, subway, bus, etc.), and the walking distance. Other modes of transportation could be added (by bicycle for example).

Send alerts to the user when the travel time and distance between the employee's or candidate's place of residence (current or future) and the place of work (current or future) match the needs of the user.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is a workflow diagram of a method for storing locations and calculating distances in accordance with the principles of the present invention. The FIG. 1 comprises the following sub-figures:

FIG. 1a is a schematic representation of the storage of locations

FIG. 1b is a schematic representation of the calculation of distances.

FIG. 2 is a schematic representation of a method used to find the longitude and the latitude from an address by using a Web service in accordance with the principles of the present invention. The FIG. 2 comprises the following sub-figures:

FIG. 2a is a portion showing the analysis of the address to be located.

FIG. 2b is a section of the schematic representation of FIG. 2 showing a request for localizing the address.

FIG. 2c is a section of the schematic representation of FIG. 2 showing representation of the answer.

FIG. 3 is a schematic representation of a method used to compute the distance between two points by using the stored locations in the system by sending them to the Web service in accordance with the principles of the present invention. The FIG. 3 comprises the following sub-figures:

FIG. 3a is a schematic representation of the retrieval of locations for which the distances must be calculated.

FIG. 3b is a schematic representation of the calculation of distances.

FIG. 3c is a schematic representation of the storage.

FIG. 3d is a schematic representation of the response.

FIG. 4 is a schematic representation a example of technical architectures that may be used to implement an embodiment of the present invention.

### DETAILED DESCRIPTION OF THE PREFERRED EMBODIMENT

A novel method and system for decision support in relation to geolocalization of a candidate's residence and workplace will be described hereinafter. Although the invention is described in terms of specific illustrative embodiment(s), it is to be understood that the embodiment(s) described herein are by way of example only and that the scope of the invention is not intended to be limited thereby.

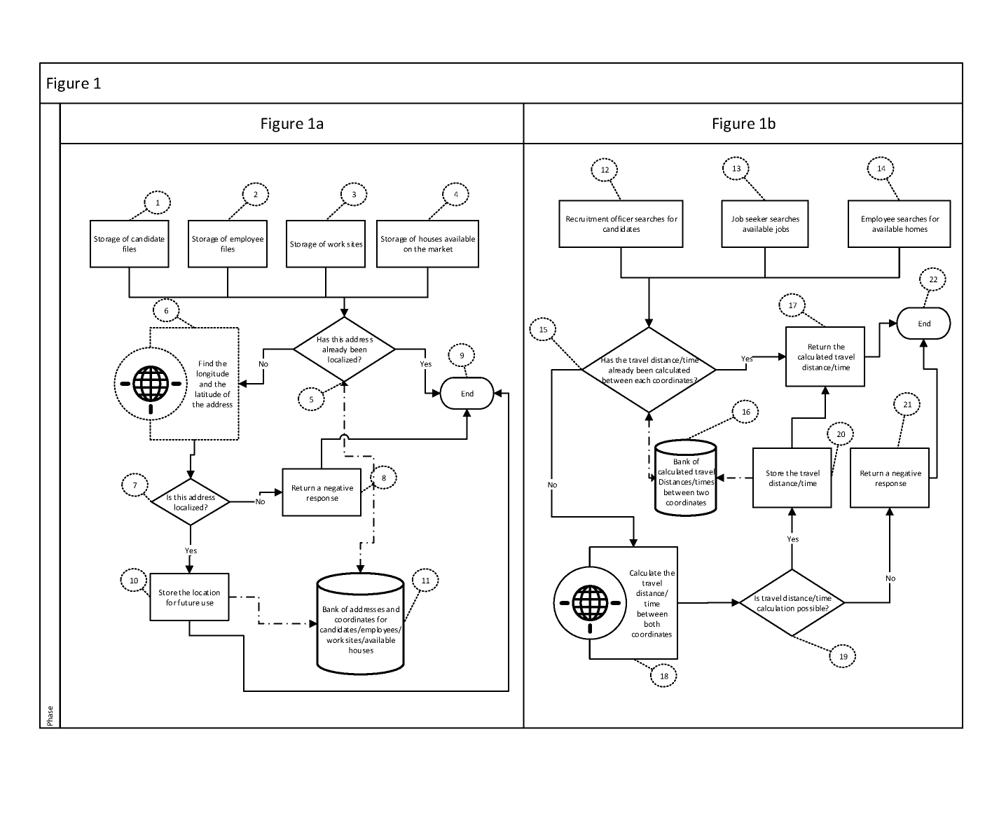

Now referring to FIG. 1, a method for decision support in relation to geolocalization of a candidate's residence and workplace is shown. Such a method for decision-making typically comprises one or more data sources allowing the storage of one or more candidate files 1, one or more employee files 2, one or more worksites 3 and a plurality of houses, land and/or building available, typically for sale or for rental, on one or more selected markets.

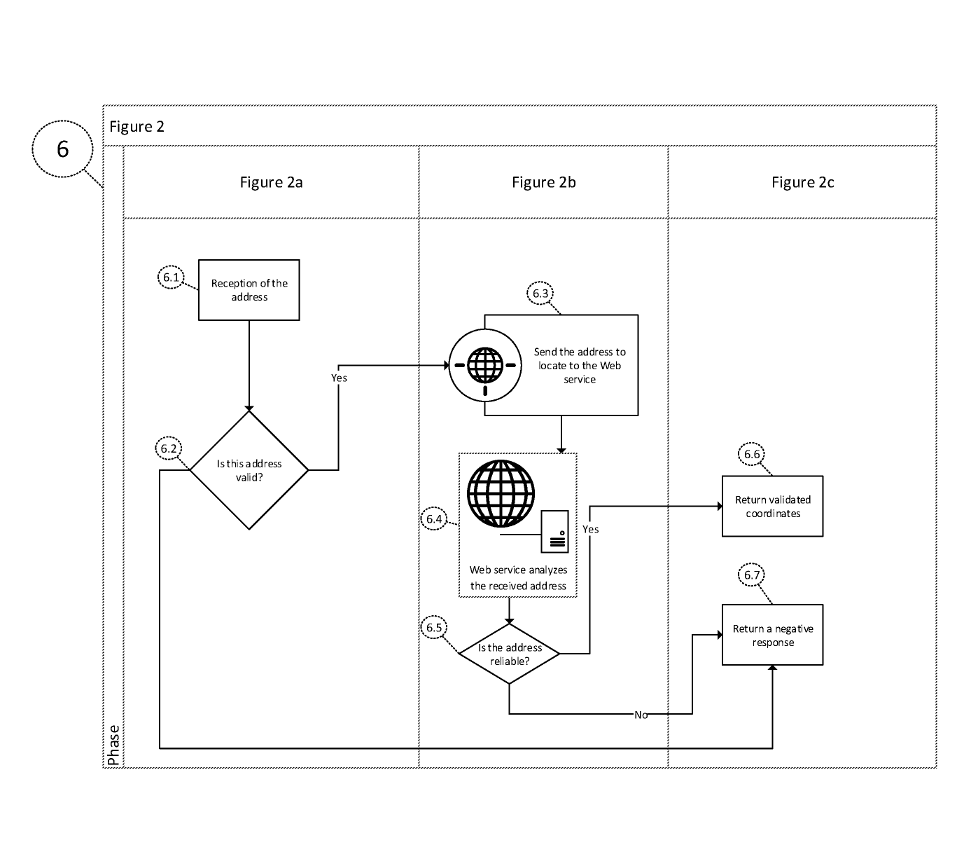

Now referring to FIG. 2, a method to find the geolocalization coordinates of a location 6 is shown. The method to find the coordinates comprises the steps to receive one or more an address 6.1, to validate the received one or more addresses 6.2, to communicate the address to locate to a system allowing the fetching of the longitude and latitude of a formatted address 6.3 and to analyze the address 6.4. In the event of the validation failing, the method 6 may comprise the steps to determine if the address to located reaches a predetermined reliability level 6.5, to return the validated coordinates 6.6, typically the longitudes and latitudes or to otherwise return a negative response (rejection) comprising the error information and an optional list of possible addresses 6.7.

The step to validate the address 6.2 may use any type of predefined criteria to ensure that the address to locate is valid, such as, but not limited to the minimum number of fields required and/or the normalized structure of the address.

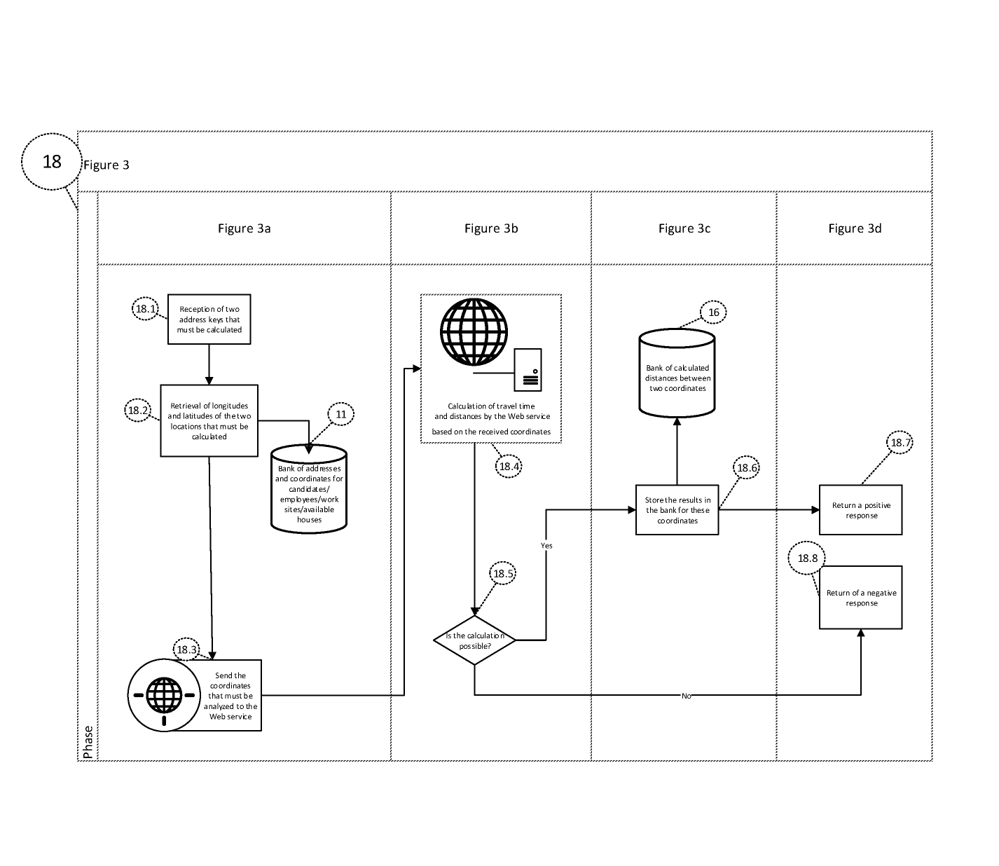

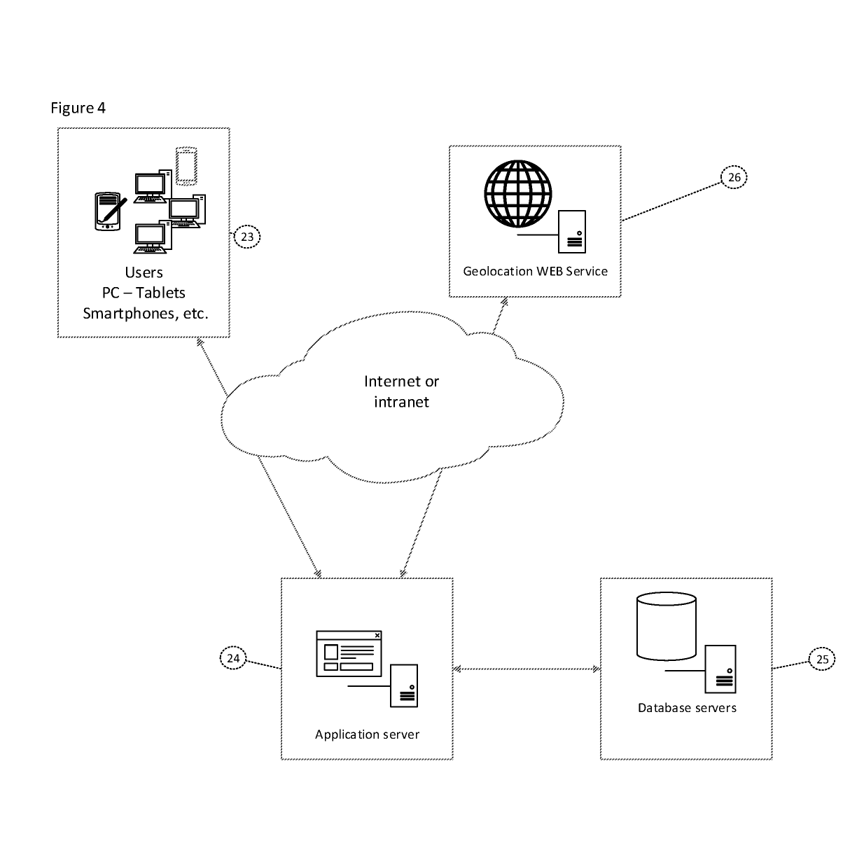

Now referring to FIG. 3, a method used to compute the distance between two location points 18 is shown. The method generally comprises a step to receive two points 18.1, such as two address locations or two coordinates, for which the travel/time distance computation is required. The method further comprises the step to retrieve the longitude and latitude of the two locations 18.2 to be computed from a data source comprising the addresses and coordinates of different locations 11, such as employees' home address, work sites. The method further comprises a step to communicate the retrieved coordinates to a system configured to analyse the said coordinates 18.3. The system is typically configured to receive the coordinates through an API, such as web services. The system configured to analyse the coordinated computes the travel distance/time between the received coordinates 18.4 and determines if the calculation is possible 18.5. In the event where the calculation is possible, the method comprises a step to store the computed travel distance/time between the two points into a data source 18.6 and 16 and return a positive answer 18.7 comprising the travel distance/time information. In the event where the computation is not possible, the system returns of a negative response 18.8 with optional error information.

### The Address Inquiry Process

Typically, the input of new data in the system, such as address and/or coordinates of locations shall trigger a validation process to validate that the inputted data is valid (i.e. real location coordinate have been associated with this address). In cases where the address has already been located, the association process is completed. In other cases, the system will inquire about the geolocalization coordinates of the address. If no coordinate is recovered for this address, the system will get a negative response to this entry otherwise, the obtained location coordinates will be stored for future use. The addresses and coordinate are stored in a bank of addresses and coordinates for candidate/employees/worksite/available houses. To complete the inquiry process 9.

According to one embodiment of the present invention, the geolocalization data of the at least one received location information is retrieved from an external system connected through the computer network. The decision support system further comprisess at least one data source configured to store a job offering associated to one or more worksite location, at least one client device configured to allow the input of at least one criterion relating to the stored job offering and at least one application server configured to receive the at least one inputted criterion from the client device.

In another embodiment, the at least one data source may be further configured to store at least one candidate data applying for at least one stored job offering. In such an embodiment, the client device is configured to allow a user to file an application relating to at least one stored job offering.

In a further embodiment, the application server may be configured to publish the stored job offerings via public or internal communication method or system. Upon reception of the filed application, to the system is configured to compute the at least one travel parameter and to store the information about the candidate in the at least one data source.

### EXAMPLE 1

### Use From a Recruitment Staff Perspective

According to one embodiment of the present invention, the typical users of the geolocation decision-making assistant system are the employees of a company recruitment department or human resource department. Such users generally use a recruitment software application to survey the job applicants and their profile. The users typically create a job offering in the system. The job offering shall comprise one or more data relating to the location of the job function (i.e. the division, the city, etc.). As soon as the data is inputted or after multiple data inputs in the system (depending on the availability of the servers), the system tries to locate the location using the inputted data. Typically, the system shall fetch the coordinates in the data source comprising stored locations and their associated coordinates. If the data source already comprises the coordinates, a link is created between the location and the fetched coordinates. If no coordinates are found, the system will use an external system to fetch the geolocalization data relating to the inputted location, typically using API or Web Services. This retrieved data associated to the location is stored in the data source to be used as a cache for future location requests.

The system may also allow a user to publish the job offerings on any public communication method or system, such as intranet or extranet websites, mobile applications or online job boards or software. When a candidate is interested in a specific job offering, the candidate may directly apply using the public communication, which generally converts the candidate job application into an electronic format compatible with the job offering public communication system. Upon reception of the job application, the system processes and stores the information relating to the candidate in a data source. Candidates may also send their resume by mail or email, in which case their application is manually inputted in the system by a user.

Referring back to FIG. 1a, upon reception of the data from the job candidate, the system attempts to locate the job candidate. The system first generally validates whether or not the location data is stored in the data source. In the event where the location data is found, the system associates the candidate data to the found location data. If no location data is found relating to the candidate, the system will use an external system to fetch the geolocalization data relating to the inputted location, typically using API or Web Services. This retrieved data associated to the location is stored in the data source to be used as a cache for future location requests.

Now referring to FIG. 1b, the system automatically or manually associates one or more candidates to the job posting. Upon creation of the said one or more association, the system computes the distance and the travel time between the candidate location data and the location data of the site associated to the job posting. These computations may be calculated for one or more modes of transportation such as car, public transit, bicycle or walk.

At any given time, the user may fetch a list of candidates for a specific job offering stored in the data source. The fetching may use any combination of any searching, sorting and/or filtering criteria. The system may also display the results with residence/workplace distance or travel time, thus helping the recruitment staff to select an appropriate candidate for a specific job offering. Considering that travel time is becoming a major factor for employee retention, this new job posting parameter is very important in the recruitment process to reduce the turnover rates. Currently, the computation of the travel time and distance is done manually, it is often estimated. In general, the travel time and distance computation is only estimate toward at the end of the process, whereas such recruitment task should in fact be completed at the beginning of the process, thus optimizing processing time. In addition, the system may take traffic information, such as real time information or average data, to calculate the average travel time of a candidate. As such, the computation obtained by the user is more accurate compared to the manual computation process.

According to another embodiment of the present invention, the system comprises at least one data source and the geolocalization data of the at least one received location information may be stored in the at least one data source to be used as a cache.

According to another embodiment of the present invention, the computation of the travel time uses traffic level as a parameter. Such parameter may be travel duration and travel distance.

According to a further embodiment of the present invention, the method for decision support may further comprise, the step to retrieve the geolocalization data of the at least one received location information is done via an external system connected through the computer network.

According to another embodiment of the present invention, the method may further comprise the step to store one or more a job offerings associated to one or more worksite location in at least one data source and to input at least one criterion relating to the stored job offering wherein the fetched worksite location information are associated to the at least one inputted criterion relating to the stored job offerings

According to another embodiment of the present invention, the method may further comprise the steps to store at least one candidate data applying for at least one stored job offering, file an application relating to at least one stored job offering, publish the stored job offerings via a public or internal communication method, such as a job board, and upon reception of the filed application, compute the at least one travel parameters and to store the information about the candidate in the at least one data source.

According to another embodiment of the present invention, the method may further comprise a step to compute the at least one travel parameter between each candidate location and at least one newly published job offering upon publication of the said job offering.

### EXAMPLE 2

### Use by a Person Who is Searching for a Job

Job seekers often search using a variety of different criteria. One of the main criteria is the travel time between their place of residence and the place of work.

According to one embodiment, the system allows a job seeker to log on the system, typically through a web site or a mobile application interface. If the job seeker does not have an account, the system allows the creation of a user account by inputting the address of one or more current or projected places of residence. Upon reception of the data from the job seeker, the system attempts to locate the job seeker using the inputted data. The system first generally validates whether or not the location data is stored in the data source. In the event where the location data is found, the system associates the job seeker data to the found location data. If no location data is found relating to the job seeker, the system will use an external system to fetch the geolocalization data relating to the inputted location, typically using API or Web Services. This retrieved data associated to the location is stored in the data source to be used as a cache for future location requests.

According to one embodiment, the system is typically linked to online job boards or may have its own job data source. Upon the addition of a new job posting to the system, the address of the work site is inputted. Upon reception of the data relating to the work site, the system attempts to locate the work site. The system first generally validates whether or not the location data is stored in the data source. In the event where the location data is found, the system associates the work site data to the found location data. If no location data is found relating to the work site, the system will use an external system to fetch the geolocalization data relating to the inputted location, typically using API or Web Services. This retrieved data associated to the location is stored in the data source to be used as a cache for future location requests.

Job seekers typically base their new job or positions search on several criteria. The travel time (depending on the mode of transportation used) is one of these criteria. According to one embodiment, the system fetches and displays the job offers that are located within a predetermined radius. The system may also display the travel time which may or may not take into consideration the traffic levels.

According to another embodiment, the system allows the job seeker to receive daily, weekly or monthly periodic alerts on certain job search criteria. Another feature of the system is the communication to job seekers of one or more instantaneous alerts upon detection of one or more job postings that meet certain predetermined criteria. As such, in the event where a new job offering is posted which meets the predetermined criteria and the maximum predetermined travel time of a job seeker, the system will instantly communicate an alert to the job seeker. The communication of the alert may be done via email, text message or any other suitable electronic communication methods deemed acceptable by the job seeker. Each time a new job offer is added to the database, the system calculates the distances and the average travel time between the new job and the job seeker's address, while verifying whether this job offer meets the criteria of any nearby job seeker, including the travel time and distance, as shown in the method presented in Figure lb.

According to another embodiment, a job seeker may configure the system to communicate another alert when the job seeker is physically located within a certain distance from a place of work offering a job which meets one or many job seeker's criteria. As such, a mobile device runs one or more computer programs that synchronize and store manually or at predetermined frequency the locations of job offerings that meet the job seeker's criteria. The computer program is typically configured to send an alert to the job seeker user when he approaches the location of a job that meets his criteria.

According to another embodiment of the present invention, the method for decision support may further comprises the step to communicate an alert to the client device comprising the at least one job offering published within a predetermined time range and associated to one or more criteria. The one or more criteria associated to the communication of the alert may bee the at least one predetermined travel parameter between the published job offering and the received location information.

According to another embodiment of the present invention, the fetched worksites information may have at least one computed travel parameter being inferior or equal to at least one respective predetermined travel parameter of the at least one received location information.

According to a further embodiment of the present invention, the step to compute the travel time of the present method may use traffic level as a parameter. In another embodiment, the travel parameters may comprise the travel duration and/or the travel distance.

According to another embodiment of the present invention, the method may further comprise the step to send an alert to the client device when the client device is geographically located within a predetermined radius of at least one stored worksite linked to at least one job offering.

According to one embodiment of the present invention, the system may comprise at least one application server configured to fetch the worksite information having at least one computed travel parameter inferior or equal to a respective predetermined parameter of the at least one received location information.

According to another embodiment of the present invention, the application server of the server may be preferably configured to send an alert to the client device when the client device is geographically located within the radius of at least one stored worksite linked to at least one job offering. Also, the application server may be configured to communicate an alert to the client device comprising the at least one job offering published within a predetermined time range and associated to one or more criteria. In another embodiment, the one or more criteria associated to the communication of the alert may be a predetermined travel parameter between the published job offering and the received location information.

In a further embodiment, the application server may be configured to compute the at least one travel parameter between each candidate location and at least one newly published job offering upon publication of the said job offering.

### EXAMPLE 3

### Use by a Person Who is Looking to Buy or Rent a Residence

According to another embodiment, the system in accordance with the principles of the present invention is configured for one or more job seekers or employees to easily locate available locations, such as houses, lands or buildings, within predetermined criteria such as travel distance and travel time from their work place. Employee getting a promotion or being newly employed often searches for nearby properties without the ability to have the available houses displayed as part of the job search. The system, according to one embodiment, will display the locations available for rent or for sale which are within predetermined criteria. According to another embodiment, the system may automatically use the workplace location and display as part of the job search results, the available locations within a certain travel distance or travel time from the workplace location. As such, the system in accordance with the principles of the present embodiment allow a job seekers or employees to retrieve more complete information when seeking employment opportunities, such as retrieving information about the real estate market in the neighborhood without the use of a real estate broker. For example, a New York employee looking for a job or a transfer to Miami shall retrieve available houses in the surrounding areas while fetching job opportunities.

According to another embodiment, the house search may also be conducted by job seeker looking for a house in a neighbourhood having a certain concentration of job opportunities. As such, the house searching could be used in the opposite way. In such an embodiment, the user would enter at least one house search criteria and job seeking opportunities and the system would return a list of houses and the number of job opportunities corresponding to the job search criteria for each house result. The user may then view either the detailed information about the house and/or about the job opportunities available in the area.

According to one embodiment, a home seeker may log on to the system through any communication method, such as a web site or a mobile application interface. The home seeker then creates a user account by entering the address of his current, future or desired work site. Upon reception of the data relating to the work site, the system attempts to locate the work site. The system first generally validates whether or not the location data is stored in the data source. In the event where the location data is found, the system associates the seeker identification data to the found location data. If no location data is found relating to the work site, the system will use an external system to fetch the geolocalization data relating to the inputted location, typically using API or Web Services. This retrieved data associated to the location is stored in the data source to be used as a cache for future location requests.

According to one embodiment, the system may be linked to sites that contain available houses/lands/buildings for sale or rent. According to another embodiment, the system may have its own house bank or have a hybrid system using its house bank in combination with available house search bank. Upon addition of a new house to the system, its address must be provided. Upon reception of the data relating to the home site, the system attempts to locate the home site. The system first generally validates whether or not the location data is stored in the data source. In the event where the location data is found, the system associates the home site data to the found location data. If no location data is found relating to the work site, the system will use an external system to fetch the geolocalization data relating to the inputted location, typically using API or Web Services. This retrieved data associated to the location is stored in the data source to be used as a cache for future location requests.

The home seeker typically searches for a home based on several criteria. The travel time (depending on the mode of transportation used) is generally one of these criteria. The system in accordance with the principles of the present invention finds the homes that could potentially meet the needs of the home seeker, including criteria such as the requested travel time. The home seeker may also subscribe to receive an alert through email, text or any other suitable and agreed upon alerts. The system communicates the alerts to the home seeker when a new location becomes available within a certain desired area or when the new house meets the criteria stored in the system by the home seeker (such as the travel time). The addition of a new house to the system triggers a computation of the distances between the new houses and the house seekers' worksites (as shown in FIG. 1b). In addition to this distance computation, the addition of a new house triggers the system to verify if this new house meets the criteria of any specific search criteria such as travel time and distance previously entered or for which a user has requested an update or alert.

According to another embodiment, a home seeker has the ability to require an alert from the system when the home seeker is geographically located within a certain distance or radius from an available house meeting his pre-established criteria. As such, the user's mobile device is configured to run a computer program that periodically or punctually synchronizes and stores the locations of houses that meet the house seeker's pre-established criteria. The computer program is also configured to calculate the current position of the home seeker and to alert the user when approaching the location of a house that meets his criteria.

According to one embodiment of the present invention, the geolocalization data of the at least one received location information is typically retrieved from an external system connected through a computer network.

According to another embodiment of the present invention, the system comprises at least one application server which may be configured to fetch the locations available for rent or for sale having at least one computed travel parameter that is inferior or equal to at least one respective predetermined parameter of the at least one received worksite location information. In a further embodiment, the geolocalization data of the at least one received worksite location information may be stored in the at least one data source to be used as a cache

According to another embodiment of the present invention, the computation of the travel time may use traffic level as a parameter. Furthermore, the travel parameters may comprise at least one of the the travel duration and/or the travel distance.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A decision support system in relation to a position of residence of a user, wherein the system comprises:
at least one data source configured to store:
a plurality of location information;
a plurality of geolocalization data associated to at least one stored location information; and
a plurality of worksites information associated to at least one geolocalization data;
at least one client device configured to input at least one residence information of the user;
an application server configured to:
receive the at least one residence information of the user;
receive at least one criterion relating to the worksite;
fetch geolocalization data associated to the worksite relating to the at least one criterion from the at least one data source;
retrieve geolocalization data of the at least one received location information;
compute at least one travel parameters between each fetched geolocalization data associated to the worksite and the retrieved geolocalization data from the at least one received location information; and
fetch the one or more stored worksites information having at least one computed travel parameters which is inferior to at least one respective predetermined travel parameter; and
a computer network connecting the at least one client device to the application server.

2) The decision support system of claim 1, wherein the geolocalization data of the at least one received location information is retrieved from an external system connected through the computer network.

3) The decision support system of claim 1,
wherein the at least one data source is further configured to store a job offering associated to one or more worksite location;
wherein the client device is configured to allow input of at least one criterion relating to the stored job offering; and
wherein the application server is configured to receive the at least one inputted criterion from the client device.

4) The decision support system of claim 3,
wherein the at least one data source is further configured to store at least one candidate data applying for at least one stored job offering;
wherein the client device is configured to allow a user to file an application relating to at least one stored job offering; and
wherein the application server is configured
to publish the stored job offerings via public communication method; and
upon reception of the filed application, to compute the at least one travel parameter and to store the information about the candidate in the at least one data source.

5) The decision support system of claim 1, wherein the application server is configured to send an alert to the client device when the client device is geographically located within the radius of at least one stored worksite linked to at least one job offering.

6) The decision support system of claim 4, wherein the application server is configured to compute of the at least one travel parameter between each candidate location and at least one newly published job offering upon publication of the said job offering.

7) The decision support system of claim 6, wherein the application server is configured to communicate an alert to the client device comprising the at least one job offering published within a predetermined time range and associated to one or more criteria.

8) The decision support system of claim 7, wherein the one or more criteria associated to the communication of the alert is a predetermined travel parameter between the published job offering and the received location information.

9) The decision support system of claim 1, wherein the application server is configured to fetch the worksite information having at least one computed travel parameter inferior or equal to a respective predetermined parameter of the at least one received location information.

10) The decision support system of claim 1, wherein the geolocalization data of the at least one received location information is stored in the data source to be used as a cache.

11) The decision support system of claim 1, wherein the computation of a travel time uses traffic level as a parameter.

12) The decision support system of claim 1, wherein one of the travel parameters is a travel duration.

13) The decision support system of claim 1, wherein one of the travel parameters is a travel distance.

14) A decision support system in relation to a location of the worksite of a user, wherein the system comprises:
at least one data source configured to store:
a plurality of geolocalization data associated to at least one residence location information available for rent or for sale; and
a plurality of worksites information associated to at least one geolocalization data;
at least one client device configured to input at least one worksite information of the user;
an application server configured to:
receive the at least one worksite information of the user;
fetch geolocalization data associated to the location available for rent or for sale relating to the at least one criterion from the at least one data source;
retrieve geolocalization data of the at least one worksite location information;
compute at least one travel parameters between each fetched geolocalization data associated to each fetched location available for sale or rent and the retrieved geolocalization data from the at least one receive worksite location information; and
fetch the one or more residence locations information available for sale or for rent having at least one computed travel parameters which is inferior to at least one respective predetermined travel parameter; and
a computer network connecting the at least one client device to the application server.

15) The decision support system of claim 14, wherein the geolocalization data of the at least one received location information is retrieved from an external system connected through the computer network.

16) The decision support system of claim 14, wherein the application server is configured to fetched the location available for rent or for sale having at least one computed travel parameter that is inferior or equal to at least one respective predetermined parameter of the at least one received worksite location information.

17) The decision support system of claim 14, wherein the geolocalization data of the at least one received worksite location information is stored in the data source to be used as a cache.

18) The decision support system of claim 14, wherein the computation of a travel time uses traffic level as a parameter.

19) The decision support system of claim 14, wherein one of the travel parameters is a travel duration.

20) The decision support system of claim 14, wherein one of the travel parameters is a travel distance.

21) A method for decision support in relation to a position of residence of a user, wherein the method comprises the steps to:
input at least one residence information of the user;
fetch geolocalization data associated to the worksite relating to the at least one criterion from the at least one data source;
retrieve geolocalization data of the at least one received location information;
compute at least one travel parameter between each fetched geolocalization data associated to the worksite and the retrieved geolocalization data from the at least one receive location information;
fetch the one or more stored worksites information having at least one computed travel parameters which is inferior to at least one respective predetermined travel parameter; and
communicate and display the fetch stored worksite information on a client device connected to the system through a computer network.

22) The method for decision support of claim 21, wherein the step to retrieve the geolocalization data of the at least one received location information is done via an external system connected through the computer network.

23) The method for decision support of claim 21, wherein the method further comprises the steps of:
storing one or more job offerings associated to one or more worksite locations in at least one data source; and
inputting at least one criterion relating to the stored job offering(s); and
wherein the fetched worksite location information are associated to the at least one inputted criterion relating to the stored job offering(s).

24) The method for decision support of claim 23, wherein the method further comprises the steps to:
store at least one candidate data applying for at least one of the stored job offering(s);
file an application relating to at least one of the stored job offering(s);
publish the stored job offering(s) via a public communication method; and
upon reception of the filed application, compute the at least one travel parameters and store the information about the candidate in the at least one data source.

25) The method for decision support of claim 23, wherein the method further comprises the step to send an alert to the client device when the client device is geographically located within a predetermined radius of at least one stored worksite linked to at least one job offering.

26) The method for decision support of claim 23, wherein the method further comprises a step to compute the at least one travel parameter between each candidate location and at least one newly published job offering upon publication of the said job offering.

27) The method for decision support of claim 26, wherein the method further comprises the step to communicate an alert to the client device comprising the at least one job offering published within a predetermined time range and associated to one or more criteria.

28) The method for decision support of claim 27, wherein the one or more criteria associated to the communication of the alert is at least one predetermined travel parameter between the published job offering and the received location information.

29) The method for decision support of claim 21, wherein the fetched worksite information have at least one computed travel parameter inferior or equal to at least one respective predetermined travel parameter of the at least one received location information.

30) The method for decision support of claim 21, wherein the step to compute a travel time uses traffic level as a parameter.

31) The decision support method of claim 21, wherein one of the travel parameters is a travel duration.

32) The decision support method of claim 21, wherein one of the travel parameters is a travel distance.
